(19) United States
(12) Patent Application Publication
(10) Pub. No.: US 2024/0405560 A1
(43) Pub. Date: Dec. 5, 2024

(54) BATTERY CHARGING DEVICE

(71) Applicants: HYUNDAI MOTOR COMPANY, Seoul (KR); KIA CORPORATION, Seoul (KR)

(72) Inventors: Young Jin Jang, Seoul (KR); Sung Hwan Kim, Anyang-si (KR); Won Yong Sung, Hwaseong-si (KR); Dong Jun Lee, Suwon-si (KR); Hye Seung Kim, Gunpo-si (KR)

(73) Assignees: HYUNDAI MOTOR COMPANY, Seoul (KR); KIA CORPORATION, Seoul (KR)

(21) Appl. No.: 18/376,210

(22) Filed: Oct. 3, 2023

(30) Foreign Application Priority Data
May 31, 2023 (KR) 10-2023-0070380

(51) Int. Cl. H02J 3/32; H02J 7/00; H02M 1/00; H02M 1/42; H02M 3/335

(52) U.S. Cl. CPC H02J 3/322; H02J 7/0047; H02J 7/0068; H02J 7/00712; H02M 1/0058; H02M 1/4208; H02M 3/33584; H02J 2207/20

(57) ABSTRACT

A battery charging device includes: a bidirectional charger having a charge and discharge port and a discharge port and connected to a battery, wherein the bidirectional charger includes a power factor correction circuit having first, second, and third legs; and a controller. The controller is configured to switch the first and third legs so that the bidirectional charger outputs a power of the battery to the charge and discharge port when a first battery discharge mode is performed, and to switch the second and third legs so that the bidirectional charger outputs the power of the battery to the discharge port when a second battery discharge mode is performed.

### CROSS REFERENCE TO RELATED APPLICATIONS

The present application claims priority to Korean Patent Application No. 10-2023-0070380, filed May 31, 2023, the entire contents of which are incorporated herein for all purposes by reference.

### TECHNICAL FIELD

The present disclosure relates to a battery charging device that performs a battery discharge mode.

### BACKGROUND

In recent years, the global trend toward reducing carbon dioxide emissions has led to a significant increase in demand for electrified vehicles. Electric vehicles generate driving power by a motor using electrical energy stored in an energy storage device such as batteries, instead of using a typical internal combustion engine that generates driving power through the combustion of fossil fuel in the engine.

Electrified vehicles may be equipped with an onboard charger (OBC) that charges a battery from system power. In general, the on-board charger (OBC) comprises: a power factor correction (PFC) circuit that converts an external alternating current (AC) voltage to a direct current (DC) voltage, and a DC-DC converter that adjusts the converted DC voltage to a voltage required by the battery.

Recently, as capacities of batteries provided in electrified vehicles have increased, Vehicle-to-grid (V2G) and Vehicle-to-load (V2L) have been developed to supply energy stored in the battery to grid and electrical loads through an on-board charger (OBC).

The description provided above as a related art of the present disclosure is just for helping understand the background of the present disclosure and should not be construed as being included in the related art known by those having ordinary skill in the art.

### SUMMARY

The present disclosure provides a battery charging device in which battery power is simultaneously output to a plurality of ports by using one bidirectional charger (an onboard charger (OBC)) when performing a battery discharge mode, and when the battery discharge mode is switched, an inrush current is mitigated.

Technical objectives to be achieved in the present disclosure are not limited to the above-mentioned technical objectives, and other technical objectives not mentioned should be clearly understood by those having ordinary skill in the art from the description below.

In order to achieve the objectives of the present disclosure, a battery charging device includes: a bidirectional charger having a charge and discharge port and a discharge port and connected to a battery. In particular, the bidirectional charger includes a power factor correction circuit having a first leg, a second leg, and a third leg. The battery charging device further includes a controller configured to switch the first and third legs so that the bidirectional charger outputs a power of the battery to the charge and discharge ports when a first battery discharge mode is performed. The controller is further configured to switch the second and third legs so that the bidirectional charger outputs the power of the battery to the discharge port when a second battery discharge mode is performed.

In one embodiment, each of the output voltages of the charge and discharge port and the discharge port may be preset to have the same frequency and phase in a simultaneous driving mode in which the first battery discharge mode and the second battery discharge mode are performed simultaneously.

In one embodiment, the controller may perform the simultaneous driving mode when zero crossing of the output voltage of the charge and discharge port is performed in a case in which a mode switching command for the simultaneous driving mode is generated in the first battery discharge mode and may perform the simultaneous driving mode when zero crossing of the output voltage of the discharge port is performed in a case in which the mode switching command for the simultaneous driving mode is generated in the second battery discharge mode.

In one embodiment, the controller may stop the performance of the first battery discharge mode when a mode switching command for the second battery discharge mode is generated in a case in which the mode switching command for the second battery discharge mode is generated in the first battery discharge mode and perform the second battery discharge mode when the zero crossing of the output voltage of the charge and discharge port is performed, and may stop the performance of the second battery discharge mode when a mode switching command for the first battery discharge mode is generated in a case in which the mode switching command for the first battery discharge mode is generated in the second battery discharge mode, and perform the first battery discharge mode when the zero crossing of the output voltage of the discharge port is performed.

In one embodiment, the bidirectional charger may further include: a first relay located between a first alternating current (AC) terminal of the charge and discharge port and an AC terminal of the first leg to be connected thereto; a second relay located between a second AC terminal of the charge and discharge port and an AC terminal of the second leg to be connected thereto; a third relay located between a third AC terminal of the charge and discharge port and an AC terminal of the third leg to be connected thereto; and a fourth relay located between a neutral terminal of the charge and discharge port and the AC terminal of the third leg to be connected thereto.

In one embodiment, the controller may turn on the first relay and the fourth relay when the first battery discharge mode is performed.

In one embodiment, a first end of the discharge port may be connected to the AC terminal of the second leg, and a second end of the discharge port may be connected to the AC terminal of the third leg, and the bidirectional charger may further include a fifth relay located between the first and second ends of the discharge port to be connected thereto.

In one embodiment, the controller may turn on the first, second, third relays when performing a first battery charge mode in which a three-phase AC voltage is applied to the charge and discharge port, and may switch the first, second, and third legs so that the bidirectional charger charges the battery based on the three-phase AC voltage.

In one embodiment, the bidirectional charger may further include a sixth relay located between the first AC terminal of the charge and discharge port and the AC terminal of the second leg to be connected thereto. The controller may turn on the first, fourth, and sixth relays when performing a second battery charge mode in which a single-phase AC voltage is applied to the charge and discharge port, and may switch the first, second, and third legs so that the bidirectional charger charges the battery based on the single-phase AC voltage.

In one embodiment, the bidirectional charger may further include a direct current to direct current (DC-DC) converter located between the power factor correction circuit and the battery to be connected thereto.

According to the present disclosure, battery power is simultaneously output to a plurality of ports by using one bidirectional charger (an onboard charger (OBC)) when performing a battery discharge mode, and when the battery discharge mode is switched, an inrush current is mitigated.

The effects that can be obtained in the present disclosure are not limited to the effects mentioned above, and other effects not mentioned can be clearly understood by those having ordinary skill in the art from the description below.

### BRIEF DESCRIPTION OF THE DRAWINGS

The accompanying drawings of the present specification illustrate embodiments of the present disclosure and serve to further understand the technical idea of the present disclosure together with the detailed description of the present disclosure to be described below. Accordingly, the present disclosure should not be construed as being limited only to matters described in the drawings. In order that the disclosure may be well understood, there is now described various forms thereof, given by way of example, reference being made to the accompanying drawings, in which:

FIG. 1 is a circuit diagram of a battery charging device according to one embodiment of the present disclosure;

FIG. 2 is a block diagram illustrating the configuration of a controller included in the battery charging device according to an embodiment of the present disclosure;

FIG. 3 is a diagram illustrating a process in which a first battery discharge mode is performed in the battery charging device according to an embodiment of the present disclosure;

FIG. 4 is a diagram illustrating a process in which a second battery discharge mode is performed in the battery charging device according to an embodiment of the present disclosure;

FIG. 5 is a diagram illustrating a process in which a simultaneous driving mode is performed in the battery charging device according to an embodiment of the present disclosure;

FIG. 6 is a diagram illustrating a process in which the first battery discharge mode is switched to the simultaneous driving mode in the battery charging device according to an embodiment of the present disclosure;

FIG. 7 is a diagram illustrating a process in which the second battery discharge mode is switched to the simultaneous driving mode in the battery charging device according to an embodiment of the present disclosure;

FIG. 8 is a diagram illustrating a process in which the first battery discharge mode is switched to the second battery discharge mode in the battery charging device according to an embodiment of the present disclosure; and

FIG. 9 is a diagram illustrating a process in which the second battery discharge mode is switched to the first battery discharge mode in the battery charging device according to an embodiment of the present disclosure.

### DETAILED DESCRIPTION

Hereinafter, an embodiment disclosed in this specification is described in detail with reference to the accompanying drawings, but the same or similar components are assigned the same reference numerals regardless of reference numerals, and a redundant description thereof is omitted.

In the following description, if it is decided that the detailed description of known technologies related to the present disclosure makes the subject matter of embodiments described herein unclear, the detailed description is omitted. Further, the accompanying drawings are provided only for easy understanding of embodiment disclosed in the specification, and the technical spirit disclosed in the specification is not limited by the accompanying drawings, and all changes, equivalents, and replacements should be understood as being included in the spirit and scope of the present disclosure.

In the description of the following embodiment, the term “preset” means that the value of a parameter is predetermined when using the parameter in a process or algorithm. The value of the parameter may be preset when a process or algorithm starts or may be preset during a period during which a process or algorithm is performed, depending on an embodiment.

The terms “module” and “unit” that are used for components in the following description are used only for the convenience of description without having discriminate meanings or functions.

Terms including ordinal numbers such as “first”, “second”, and the like, may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Singular forms are intended to include plural forms unless the context clearly indicates otherwise.

It should be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

A controller may include a communication device that communicates with another controller or a sensor to control corresponding functions, a memory that stores an operating system or logic commands and input/output information, and one or more that processors perform determination, calculation, decision, and the like, for controlling the corresponding functions.

When a component, device, element, or the like, of the present disclosure, is described as having a purpose or performing an operation, function, or the like, the component, device, or element should be considered herein as being “configured to” meet that purpose or to perform that operation or function.

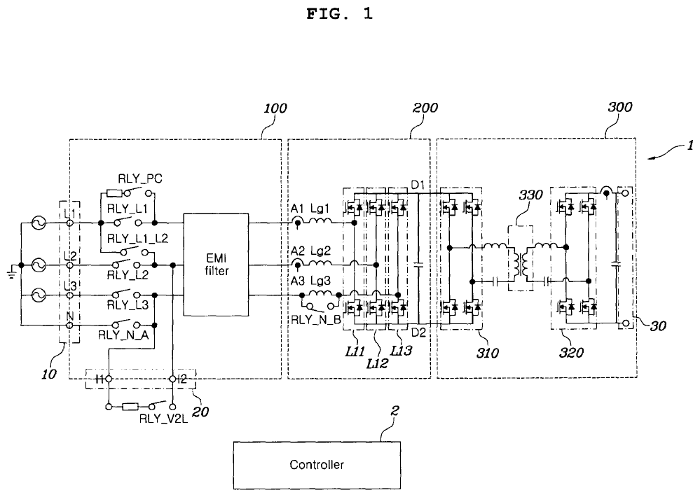

FIG. 1 is a circuit diagram of a battery charging device according to one embodiment of the present disclosure.

Referring to FIG. 1, the battery charging device may include a bidirectional charger 1 and a controller 2.

The bidirectional charger 1 has a charge and discharge port 10, a discharge port 20, and an output terminal 30 connected to the battery, and may include an input circuit 100, a power factor correction (PFC) circuit 200, and a DC-DC converter 300.

The charge and discharge port 10 includes a first alternating current (AC) terminal L1, a second AC terminal L2, a third AC terminal L3, and a neutral terminal N, and may support a battery charge mode and a battery discharge mode. In this case, the charge and discharge port 10 may be provided outside of the electrified vehicle but is not necessarily limited thereto. In the present embodiment, the battery discharge mode may correspond to a Vehicle-to-load (V2L) mode.

The discharge port 20 includes a first AC terminal I1 and the second AC terminal I2 and may support the battery discharge mode. In this case, the discharge port 20 may be provided inside an electrified vehicle but is not necessarily limited thereto. The first AC terminal I1 of the discharge port 20 may be connected to a third AC terminal A3 of a power factor correction circuit 200, and the second AC terminal I2 of the discharge port 20 may be connected to a second AC terminal A2 of the power factor correction circuit 200. In this case, a V2L relay RLY_V2L may be located between the first AC terminal I1 and the second AC terminal I2 of the discharge port 20 to be connected thereto.

The input circuit 100 may include an electromagnetic interference (EMI) filter, a pre-charge relay RLY_PC, an L1 relay RLY_L1, an L1-L2 relay RLY_L1_L2, an L2 relay RLY_L2, an L3 relay RLY_L3, and a neutral terminal relay RLY_N_A. The L1 relay RLY_L1 may be located between the first AC terminal L1 of the charge and discharge port 10 and a first AC terminal A1 of the power factor correction circuit 200 to be connected thereto. The pre-charge relay RLY_PC may be located between the first AC terminal L1 of the charge and discharge port 10 and the first AC terminal A1 of the power factor correction circuit 200 to be connected in parallel with the L1 relay RLY_L1. The L2 relay RLY_L2 may be located between the second AC terminal L2 of the charge and discharge port 10 and the second AC terminal A2 of the power factor correction circuit 200 to be connected thereto. The L3 relay RLY_L3 may be located between the third AC terminal L3 of the charge and discharge port 10 and the third AC terminal A3 of the power factor correction circuit 200 to be connected thereto. The neutral terminal relay RLY_N_A may be located between the neutral terminal N of the charge and discharge port 10 and the third AC terminal A3 of the power factor correction circuit 200 to be connected thereto.

The power factor correction circuit 200 may include a first input inductor Lg1, a second input inductor Lg2, a third input inductor Lg3, a relay RLY_N_B, a DC capacitor C1, a first leg L11, the second leg L12, and the third leg L13. The DC capacitor C1 may be located between a first DC terminal D1 and a second DC terminal D2 to be connected thereto. The first leg L11 may include two switch elements connected in series between the first DC terminal D1 and the second DC terminal D2. The first leg L11 also may have an AC terminal connected to the first AC terminal A1 of the power factor correction circuit 200 through the first input inductor Lg1. The second leg L12 may include two switch elements connected in series between the first DC terminal D1 and the second DC terminal D2. The second leg L12 also may have an AC terminal connected to the second AC terminal A2 of the power factor correction circuit 200 through the second input inductor Lg2. The third leg L13 may include two switch elements connected in series between the first DC terminal D1 and the second DC terminal D2. The third leg L13 also may have an AC terminal connected to the third AC terminal A3 of the power factor correction circuit 200 through the third input inductor Lg3. In this case, the relay RLY_N_B may be connected in parallel with the third input inductor Lg3.

The DC-DC converter 300 may be located between the DC terminals D1 and D2 of the power factor correction circuit 200 and the output terminal 30 to which the battery is connected to be connected thereto, and may convert a DC voltage between the DC terminals D1 and D2 and the output terminal 30. The DC-DC converter 300 may include a first switching circuit 310, a second switching circuit 320, a transformer 330, and a DC capacitor C2. In this case, the transformer 330 is located between the first switching circuit 310 and the second switching circuit 320 to be connected thereto, and the DC capacitor C2 is located between positive (+) and negative (−) poles of the battery the battery to be connected thereto.

The controller 2 may control the performance of the battery charge mode in which the battery is charged based on an external AC voltage through the bidirectional charger 1, and the performance of the battery discharge mode in which power of the battery is discharged to at least one of the charge and discharge port 10 and the discharge port 20 through the bidirectional charger 1.

The battery charge mode may include a first battery charge mode in which a three-phase AC voltage is applied to the charge and discharge port 10, and a second battery charge mode in which a single-phase AC voltage is applied to the charge and discharge port 10.

When the first battery charge mode is performed, the controller 2 may turn on the L1 relay RLY_L1, the L2 relay RLY_L2, and the L3 relay RLY_L3, and may switch the first leg L11, the second leg L12, and the third leg L13 of the power factor correction circuit 200 so that the bidirectional charger 1 charges the battery based on the three-phase AC voltage.

When the second battery charge mode is performed, the controller 2 may turn on the L1 relay RLY_L1, the L1-L2 relay RLY_L1_L2, the neutral terminal relay RLY_N_A, and the relay RLY_N_B, and may switch the first leg L11, the second leg L12, and the third leg L13 of the power factor correction circuit 200 so that the bidirectional charger 1 charges the battery based on the single-phase AC voltage.

The battery discharge mode may include a first battery discharge mode in which power of the battery is output to the charge and discharge port 10, and a second battery discharge mode in which power of the battery is output to the discharge port 20.

When the first battery discharge mode is performed, the controller 2 may turn on the L1 relay RLY_L1 and the neutral terminal relay RLY_N_A, and may switch the first leg L11 and the third leg L13 of the power factor correction circuit 200 so that the bidirectional charger 1 outputs power of the battery to the charge and discharge port 10.

When the second battery discharge mode is performed, the controller 2 may turn on the V2L relay RLY_V2L, and may switch the second leg L12 and the third leg L13 of the power factor correction circuit 200 so that the bidirectional charger 1 outputs power of the battery to the discharge port 20.

In addition, in the present disclosure, the controller 2 may perform a simultaneous driving mode in which the first battery discharge mode and the second battery discharge mode are simultaneously performed. In this case, since the third leg L13 is commonly used in the first battery discharge mode and the second battery discharge mode, each of the output voltages of the charge and discharge port 10 and the discharge port 20 may be preset to have the same frequency and phase in the simultaneous driving mode.

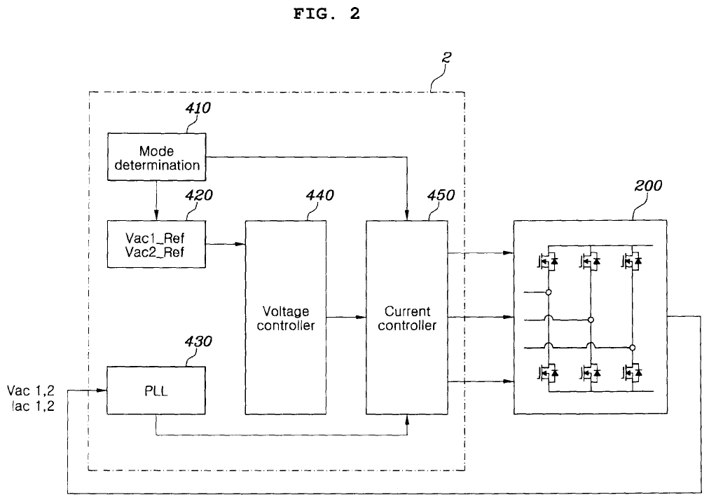

FIG. 2 is a block diagram illustrating the configuration of the controller included in the battery charging device according to an embodiment of the present disclosure. Referring to FIG. 2, the controller 2 may include: a mode determination part 410 that determines whether the battery discharge mode is the first battery discharge mode or the second battery discharge mode; a voltage command generation part 420 that generates a first voltage command Vac1_Ref for the first battery discharge mode and a second voltage command Vac2_Ref for the second battery discharge mode; a phase-locked loop (PLL) circuit 430 that generates phase information based on an output voltage Vac1 and an output current Iac1 of the charge and discharge port, and an output voltage Vac2 and an output current Iac2 of the discharge port; a voltage controller 440 that generates a current command of the power factor correction circuit 200; and a current controller 450 that switches the legs included in the power factor correction circuit 200 according to the current command.

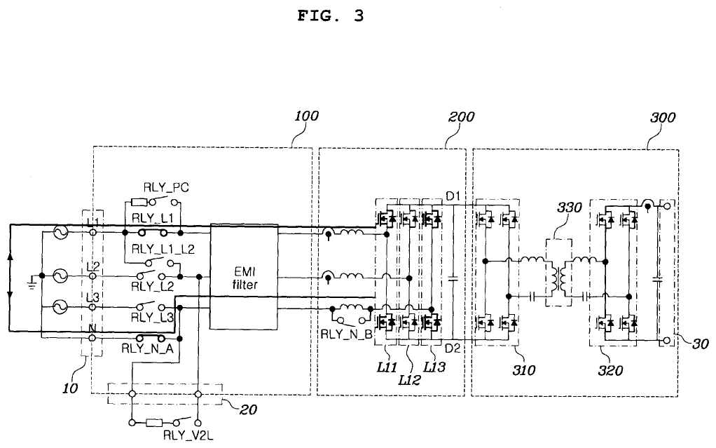

FIG. 3 is a diagram illustrating a process in which the first battery discharge mode is performed in the battery charging device according to an embodiment of the present disclosure. Referring to FIG. 3, when the first battery discharge mode is performed, the first leg L11 and the third leg L13 of the power factor correction circuit 200 may be switched, and the L1 relay RLY_L1, and the neutral terminal relay RLY_N_A may be turned on.

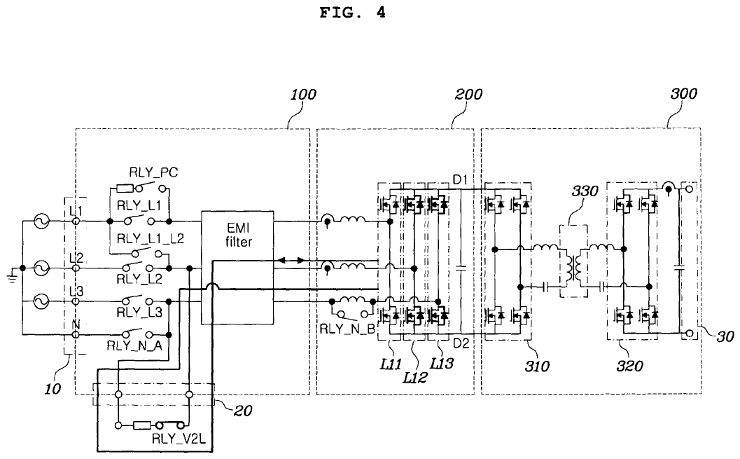

FIG. 4 is a diagram illustrating a process in which the second battery discharge mode is performed in the battery charging device according to an embodiment of the present disclosure. Referring to FIG. 4, when the second battery discharge mode is performed, the second leg L12 and the third leg L13 of the power factor correction circuit 200 may be switched, and the V2L relay RLY_V2L may be turned on.

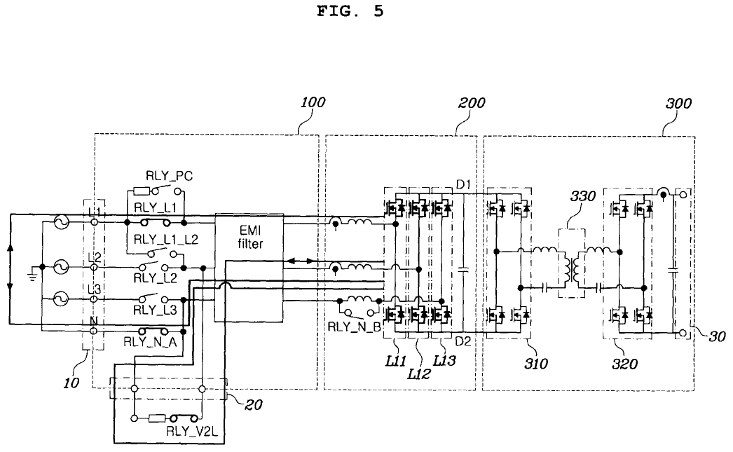

FIG. 5 is a diagram illustrating a process in which the simultaneous driving mode is performed in the battery charging device according to an embodiment of the present disclosure. Referring to FIG. 5, when the simultaneous driving mode is performed, the first leg L11, the second leg L12, and the third leg L13 of the power factor correction circuit 200 may be switched, and the L1 relay RLY_L1, the neutral terminal relay RLY_N_A, and the V2L relay RLY_V2L may be turned on.

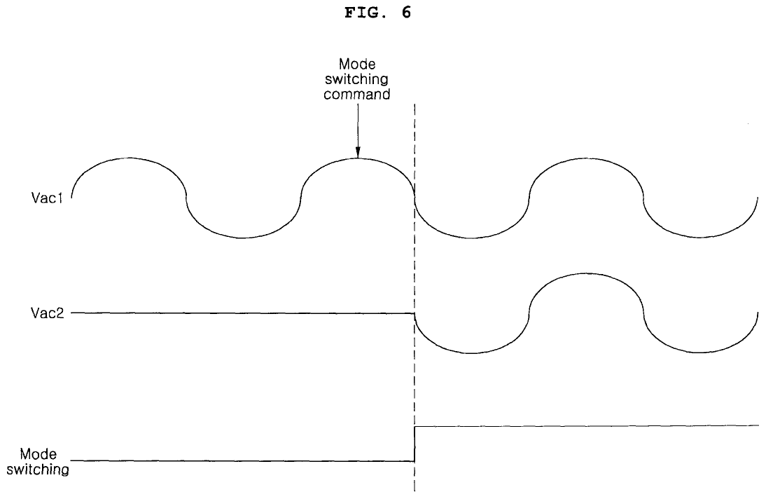

FIG. 6 is a diagram illustrating a process in which

the first battery discharge mode is switched to the simultaneous driving mode in the battery charging device according to an embodiment of the present disclosure. Referring to FIG. 6, when a mode switching command for the simultaneous driving mode is generated in the first battery discharge mode, the controller 2 may perform the simultaneous driving mode at a time at which the zero crossing of the output voltage Vac1 of the charge and discharge port is performed to minimize an inrush current. Accordingly, in the simultaneous driving mode, the output voltage Vac1 of the charge and discharge port may have the same frequency and phase as the output voltage Vac2 of the discharge port.

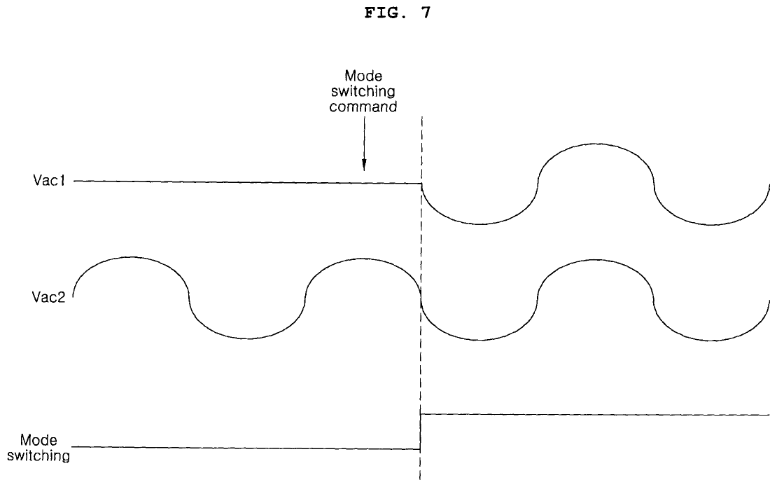

FIG. 7 is a diagram illustrating a process in which the second battery discharge mode is switched to the simultaneous driving mode in the battery charging device according to an embodiment of the present disclosure. Referring to FIG. 7, when the mode switching command for the simultaneous driving mode is generated in the second battery discharge mode, the controller 2 may perform the simultaneous driving mode at a time at which zero crossing of the output voltage Vac2 of the discharge port is performed to minimize an inrush current. Accordingly, in the simultaneous driving mode, the output voltage Vac2 of the discharge port may have the same frequency and phase as the output voltage Vac1 of the charge and discharge port.

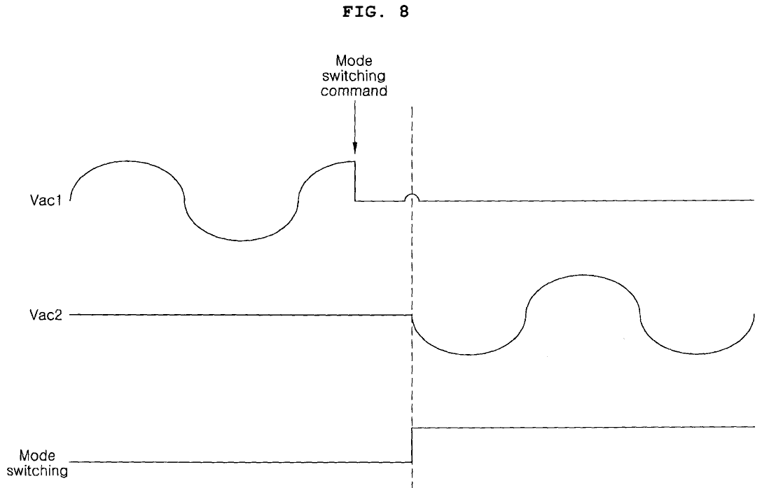

FIG. 8 is a diagram illustrating a process in which the first battery discharge mode is switched to the second battery discharge mode in the battery charging device according to an embodiment of the present disclosure. Referring to FIG. 8, in a case in which a mode switching command for the second battery discharge mode is generated in the first battery discharge mode, when the mode switching command for the second battery discharge mode is generated, the controller 2 may immediately stop the performance of the first battery discharge mode to stabilize switching control and may preset the output voltage Vac1 of the charge and discharge port to be “0”. In this case, the controller 2 may perform the second battery discharge mode in which the output voltage Vac2 of the discharge port is generated when the zero crossing of the output voltage Vac1 of the charge and discharge port has been performed.

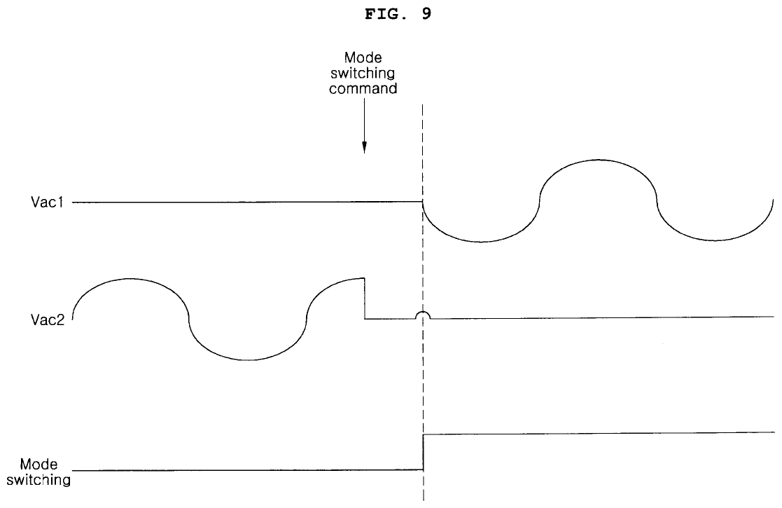

FIG. 9 is a diagram illustrating a process in which the second battery discharge mode is switched to the first battery discharge mode in the battery charging device according to an embodiment of the present disclosure. Referring to FIG. 9, in a case in which the mode switching command for the first battery discharge mode is generated in the second battery discharge mode, when the mode switching command for the first battery discharge mode is generated, the controller 2 may immediately stop the performance of the second battery discharge mode to stabilize switching control and may preset the output voltage Vac2 of the discharge port to be “0”. In this case, the controller 2 may perform the first battery discharge mode in which the output voltage Vac1 of the charge and discharge port is generated when the zero crossing of the output voltage Vac2 of the discharge port has been performed.

The present disclosure described above can be implemented as computer readable code on a medium on which a program is recorded. The computer-readable medium includes all types of recording devices in which data that can be read by a computer system is stored. Examples of computer-readable media include a hard disk drive (HDD), a solid-state disk (SSD), a silicon disk drive (SDD), read-only memory (ROM), random-access memory (RAM), a compact-disk ROM (CD-ROM), a magnetic tape, a floppy disk, and an optical data storage device, and the like. Accordingly, the above detailed description should not be construed as limiting in all respects and should be considered illustrative. The scope of the present disclosure should be determined by reasonable interpretation of the appended claims, and all changes within the equivalent scope of the present disclosure are included in the scope of the present disclosure.

1. A battery charging device comprising:
a bidirectional charger having a charge and discharge port and a discharge port and connected to a battery, wherein the bidirectional charger comprises a power factor correction circuit having a first leg, a second leg, and a third leg; and
a controller configured to:
switch the first and third legs so that the bidirectional charger outputs a power of the battery to the charge and discharge port when a first battery discharge mode is performed, and
switch the second and third legs so that the bidirectional charger outputs the power of the battery to the discharge port when a second battery discharge mode is performed.

2. The battery charging device of claim 1, wherein each output voltage of the charge and discharge port and the discharge port is preset to have the same frequency and phase in a simultaneous driving mode in which the first battery discharge mode and the second battery discharge mode are performed simultaneously.

3. The battery charging device of claim 2, wherein the controller is configured to: perform the simultaneous driving mode when zero crossing of the output voltage of the charge and discharge port is perormed when a mode switching command for the simultaneous driving mode is generated in the first battery discharge mode, and
perform the simultaneous driving mode when zero crossing of the output voltage of the discharge port is performed when the mode switching command for the simultaneous driving mode is generated in the second battery discharge mode.

4. The battery charging device of claim 3,
wherein the controller is configured to:
stop the performance of the first battery discharge mode when a mode switching command for the second battery discharge mode is generated when the mode switching command for the second battery discharge mode is generated in the first battery discharge mode, and
perform the second battery discharge mode when the zero crossing of the output voltage of the charge and discharge port is performed, and
wherein the controller is further configured to:
stop the performance of the second battery discharge mode when a mode switching command for the first battery discharge mode is generated when the mode switching command for the first battery discharge mode is generated in the second battery discharge mode, and
perform the first battery discharge mode when the zero crossing of the output voltage of the discharge port is performed.

5. The battery charging device of claim 1, wherein the bidirectional charger further comprises:
a first relay located between a first alternating current (AC) terminal of the charge and discharge port and an AC terminal of the first leg to be connected thereto;
a second relay located between a second AC terminal of the charge and discharge port and an AC terminal of the second leg to be connected thereto;
a third relay located between a third AC terminal of the charge and discharge port and an AC terminal of the third leg to be connected thereto; and
a fourth relay located between a neutral terminal of the charge and discharge port and the AC terminal of the third leg to be connected thereto.

6. The battery charging device of claim 5, wherein the controller is configured to turn on the first relay and the fourth relay when the first battery discharge mode is performed.

7. The battery charging device of claim 5, wherein a first end of the discharge port is connected to the AC terminal of the second leg, and a second end of the discharge port is connected to the AC terminal of the third leg, and
the bidirectional charger further comprises a fifth relay located between the first and second ends of the discharge port to be connected thereto.

8. The battery charging device of claim 7, wherein the controller is configured to turn on the fifth relay when the second battery discharge mode is performed.

9. The battery charging device of claim 5, wherein the controller is configured to turn on the first, second, and third relays when performing a first battery charge mode in which a three-phase AC voltage is applied to the charge and discharge port, and the controller is further configured to switch the first, second, and third legs so that the bidirectional charger charges the battery based on the three-phase AC voltage.

10. The battery charging device of claim 5, wherein:
the bidirectional charger further comprises a sixth relay located between the first AC terminal of the charge and discharge port and the AC terminal of the second leg to be connected thereto, and
the controller is configured to turn on the first, fourth, and sixth relays when performing a second battery charge mode in which a single-phase AC voltage is applied to the charge and discharge port, and configured to switch the first, second, and third legs so that the bidirectional charger charges the battery based on the single-phase AC voltage.

11. The battery charging device of claim 1, wherein the bidirectional charger further comprises a DC-DC converter located between the power factor correction circuit and the battery to be connected thereto.
